(19) United States
(12) Patent Application Publication
(10) Pub. No.: US 2007/0184320 A1
(43) Pub. Date: Aug. 9, 2007

(54) Cooling devices for various applications

(76) Inventor: Jean-Paul Domen, Vauchretien (FR)

Correspondence Address: MARSH, FISCHMANN & BREYFOGLE LLP, 3151 SOUTH VAUGHN WAY, SUITE 411, AURORA, CO, 80014, US

(21) Appl. No.: 11/571,210

(22) PCT Filed: Jun. 23, 2005
(86) PCT No.: PCT/FR05/01586

§ 371 Date: Dec. 22, 2006

(30) Foreign Application Priority Data
Jun. 24, 2004 (FR) 0406911
Oct. 20, 2004 (FR) 0411122
Dec. 27, 2004 (FR) 0413932

(51) Int. Cl. H01M 8/04; F28F 9/02

(52) U.S. Cl. 429/26; 165/173

(57) ABSTRACT

The figure displays the diagram of a laminar flow water cooler (110) for a microprocessor comprising an integral radiator (112) provided with thin-walled and hollow fins which are produced by controlled compression of double convex bellows of a polymer or glass hot-blown blank. In order to form a closed circuit filled with water at the atmospheric pressure, the manifolds (113, 114, 115) of the radiator (112) are connected to the manifolds of an original component (114) formed by a mini heater (116) provided with a copper heating plate with internal grooved face and a mini pump (118) provided with a brushless electric motor devoid of a centrifugal turbine, wherein said mini heater and mini pump are disposed in a rigid small-sized moulded polymer hose. The total thermal resistance of said cooler can be equal to 0.15°/W that is of interest, in particular for high performance microprocessors for dissipating more than 200 W through the very hot central area of 1.5 cm² of the heat dissipating surface thereof. The concept of the production of the inventive cooler makes it possible to design efficient and low-cost cooling devices which are usable for microprocessors, high-power electronic devices, thermal engines or fuel cells, in particular mounted in a motor vehicle. Said invention can be used for cooling any component dissipating a given thermal flux within the determined power and temperature limits.

### BACKGROUND OF THE INVENTION

The invention relates to a major improvement to cooling devices which operate by heat exchange between a hot liquid and a cool fluid. Principally, the invention relates to coolers producing a water/air heat exchange and, secondly, to those in which the hot liquid is different to water and/or to those in which the cold fluid is different to air.

Such cooling devices are associated with numerous components designed to dissipate a determined heat flow which, for each component concerned, depends both on the total power employed and on the yield obtained. Consequently, the heat flows relating to the coolers according to the invention are situated in two very wide ranges of powers and temperatures. By way of example, the range of these powers extends from substantially fifty Watts to substantially one hundred kilowatts. As regards the range of temperatures, its lower limit is at least a dozen degrees higher than the maximum temperature of the readily available cold fluid and its upper limit, determined by the temperature of change of state of the hot liquid, at a possible working pressure.

As regards their cooling method, these various components are distinguished from one another more by the shape of their heat dissipation surfaces than by the scale of the heat flow to be evacuated. Any cooling device, associated with a related component, has a coupling surface which is adapted to be fitted against, in a permanent or non-permanent manner, the heat dissipation surface of this component. In the first case, the surfaces in question are the two faces of walls with a straight closed section, such as those of the cylinders of an internal combustion engine, In the second case, these surfaces are flat plates which are small (<15 cm²), for a microprocessor, medium sized (<2 dm²) for a high power electronic device or relatively large (5 to 20 dm²) for bipolar plates of the cells of PEM-type (acronym for Proton Exchange Membrane) fuel cells.

Any water/air heat exchange cooling devices, coupled to the heat dissipation surface of a given component, comprises:

a heater comprising an internal cavity, provided with two manifolds, and a coupling surface, corresponding to said heat dissipation surface;

a finned radiator, provided with two manifolds;

ducts for connecting together the manifolds of the heater and of the radiator and thus constituting a tight enclosure;

water in this enclosure;

means for circulating, in a closed circuit, this water in this enclosure;

means for circulating air between the fins of the radiator.

As regards the radiator of such a cooling device, the requirement that it has a high thermal conductance as well as a reduced front surface area and/or a limited volume, applies in all cases. The overall performance of such a cooler is described by a single value, that of its total thermal resistance, which is expressed in degrees per watt (°/W) or by the inverse thereof, the thermal conductance (in Watts per degree).

By way of example, a water/air heat exchange cooler will be presented, coupled to a microprocessor which must evacuate 100 Watts, while remaining at an average temperature of 60° C. This cooler comprises a mini-heater or boiler into which the water enters at 50° C., exits at 60° C. and circulates therein at 2.4 g/s. Consequently, the average temperature of the water in the mini-heater is 55° C. and the difference between the average temperature of this water and that of the heat dissipation surface of the microprocessor is 5° C. The thermal resistance of the mini-heater coupled to this surface is 0.05°/W. For its part, the air enters the radiator at 25° C., exits from it at 45° C. and circulates therein at 5 g/s, while the average temperature of the water in the radiator is 55° C. The difference between the average temperatures of the water and of the air in the radiator is 20° C., which gives 0.20°/W for the thermal resistance of the radiator. The total thermal resistance of the cooling device in question is therefore 0.25°/W.

First of all, the cooling of microprocessors will be discussed. The techniques used for this purpose are described and commented on at length on the Internet. High-performance computer enthusiasts construct relatively efficient water coolers themselves, from components available on the market. However reservations are expressed concerning these coolers which have no unity of design, in particular as regards their bulk, cost and the noise they make due to the pump and the fan used.

Among the components of these water cooling devices for microprocessors, only the mini-heaters (or water-blocks to use the technical term) and the pumps exhibit any originality, the radiators all being of a standard type, with solid metal fins. Several mini-heaters described are blocks of copper, of approximately one hundred cm³, tooled so as to have an internal cavity provided with a metal lid generally welded and upstream and downstream connections or manifolds. Such an internal cavity is constituted either by a single channel, winding or spiral and relatively broad, equipped with connections, or by a small number of relatively narrow parallel channels, provided with manifolds. Another example of a mini-heater with microscopic channels is described in the U.S. Pat. No. 5,263,251 of 1993. It is constituted by a block, equipped with two inlet and outlet tubes, which is the result of the lamination of a stack of numerous copper foils, one face of which is etched, in order to create a fine straight or winding passage between two openings. After lamination of the stack of foils thus etched, these openings constitute the welded sections of the two internal manifolds supplying the microscopic channels resulting from the crushing of the material delimiting these passages. The heat dissipation surface of the microprocessor to be cooled is applied to a lateral wall of the thus-constituted block. This leads to a large thermal resistance for such a mini-heater.

As regards the pumps used, they are generally pumps equipped with a brushless electric motor and with a centrifugal turbine. The hydraulic power of these pumps is relatively high in order to be able to create, in a single channel mini-heater and in the associated radiator with solid fins, a circulation of water with turbulent flow, which greatly increases (up to 20 times) the apparent thermal conductivity of the water circulating in these two components. This is therefore in particular a pump, available on the market, which comprises a 25 W brushless electric motor, provided with a rotor constituted by a multipolar hemispherical magnet of approximately 5 cm in diameter, integral with a centrifugal turbine, and which provides a hydraulic power of around 5 W, with a pressure of several hundred hectopascals. Moreover, these pumps are too bulky for a computer with small dimensions and, in addition, they are relatively expensive.

To these comments relating to the mini-heaters and the pumps available on the market, one should add that, until now, practically all the manufacturers concerned have considered and treated the heat flow density passing over the heat dissipation plate of common microprocessors, as being more or less uniform, thanks to the very good thermal conductivity of this dissipation plate, and in general comprised between 5 and 15 W/cm². If this working hypothesis is generally verified for average performances microprocessors, this is not at all the case for very high-performance microprocessors, which are currently available or soon to be available on the market. These very high-performance microprocessors comprise, at the center of a conventional heat dissipation plate of approximately 12 cm², a small very hot and generally rectangular zone of approximately 1.5 cm², over which the density of the heat flow, under extreme operating conditions, can be of the order of 140 W/cm².

Another technique for water cooling of microprocessors uses a mini-heater, constituted by several hundred microscopic channels, arranged in a multilayer silicon wafer. A relatively powerful pump circulates the water in a laminar flow in these microscopic channels then in turbulent flow in a conventional finned radiator connected to a fan. This technique has the advantage of being able to correctly cool the hottest points of the component concerned. This has great benefits. But it is of course too expensive for several common applications, in particular for the PCs intended for the general public.

Another technique for water cooling of microprocessors uses one or more heat transfer tubes. These are copper tubes a few millimetres in diameter, provided over all of their length with an internal tubular wick. They contain a liquid and its vapor (in particular low-pressure water or freon) and they connect a mini-heater, integral with the heat dissipation plate of the microprocessor, to a radiator with solid metal fins, swept over by a current of air produced by a fan. The liquid contained in the mini-heater is evaporated and the vapor produced will condense in the radiator, while its latent heat is carried off by the current of air. The liquid condensed produced at this point is carried by the wick to the mini-heater, thus allowing the heat transfer cycle described to recommence. This technique is effective but expensive and cumbersome.

Another technique, similar to the previous one, is used for the simultaneous cooling of several microprocessors. By way of examples, the US patents of the Japanese companies Hitachi U.S. Pat. No. 4,502,286 of 1985 and Denso U.S. Pat. No. 6,005,772 of 1999 and U.S. Pat. No. 6,360,814 of 2002 describe several of its numerous embodiments. In these coolers, bubbles of vapor produced in the liquid contained in the heater escape from this liquid, in order to form above it free vapor which, by natural convection, can rise in the condensation chambers of radiators with solid metal fins, while the condensed liquid returns to the heater by gravity.

It will be noted that these last techniques, which use a looped circuit comprising: boiling of a liquid, production of free vapor, transportation of this vapor by natural convection, condensation of this vapor in a radiator with fins which are swept with a current of air and return by gravity of the condensed liquid, comprising several components similar to those of the known device for cooling by heat exchange between the water circulating in a looped circuit and the air, described above. But these known techniques differ in their designs, one uses the alternative changes of state of a liquid and of its vapor and the other, the heating then the cooling of a liquid which does not change state.

In the case of internal combustion engines, numerous improvements have been made to the technology of radiators with solid metal fins, but the method of cooling used has remained the same for several decades. In this method, a mechanical pump rapidly circulates, in a closed circuit, water in turbulent flow in the internal cavity of the heater provided around cylinders of the engine, then in the hoses and the radiator. The latter comprises a small number of parallel metal tubes, onto which metal fins perforated for this purpose are slid then welded or crimped. Between these fins, a current of air circulates produced by a fan and/or the relative wind of the vehicle. In the heater of the cooler, the flow of the water may not be very turbulent but still allows a good transfer of heat, since the difference in temperature is very great between the surfaces for heat dissipation of the engine and those for coupling of the cooler. In fact, the internal face of the walls of the cylinders, in contact with the very hot waste gases present at the end of each expansion, is at a very high temperature (>600° C.), while the outer face of these same walls, in contact with the flowing water, is at the temperature of this water (80° C.). Since the thermal resistance of these walls is negligible, the water flowing in the heater is subject to all of this difference in temperature. Under these conditions, the strong thermal resistivity of water in a poorly turbulent flow, subject to such a difference in temperature, is a small obstacle to a rapid and full transfer of the heat flow of the waste gases to the water current.

By contrast, the average difference in temperature between the water flowing in the tubes of the radiator and the current of air which sweeps its fins being relatively small (60° C.), it is essential that the apparent thermal resistivity of this water is as low as possible in order for the overall thermal conductance of this radiator to be as large as possible, given the value of this difference. As the hydraulic diameter and the number of tubes of the radiator cannot be very great, the only parameter available for making the flow of the water in these tubes vigorously turbulent is its circulation rate, which must therefore be relatively high. This causes a large pressure drop in the radiator, which means that the pump has to have a relatively large hydraulic power.

There are inserted, between the hot water, which circulates in the tubes of the radiator, and the outer walls of its fins, two large thermal resistances, which considerably reduce the average difference in temperature between these outer walls and the current of air which ventilates them. The first of these resistances appears in the thickness of the water itself, despite a very strong increase in its apparent heat conductivity, due to its turbulent flow. The second of these resistances appears between the outer faces of the walls of the tubes of the radiator and the total surface area of the fins attached to these walls. In this regard it will be noted that the temperature of the fins reduces rapidly from their roots to their ends, where it comes close to that of the air current. Because these two thermal resistances are placed in series, the air current which sweeps the fins of the radiator can have available to it only a limited fraction (approximately 30%) of the average difference in temperature that it exhibits vis-à-vis the water current entering the radiator, in order to carry off the heat flow to be dissipated.

By way of an example illustrating the current situation of the radiator with solid metal fins of an internal combustion engine, in order to constantly evacuate 30 kW of heat, in a water/air exchange cooling device of an engine of the same power, the pump circulates this water at 2400 g/s, at an initial temperature of approximately 80° C., in a standard radiator having a volume of 5 dm³, a front surface area (frontal area) of 17 dm² and fins of 10 m². As it passes over this radiator, the water loses approximately 3° C. while an air current of 2 kg/s (1.65 m³/s), which penetrates between these hot fins at 10 m/s, increases its temperature by 15° C., which changes for example from 25 to 40° C. The thermal resistance of this radiator with solid metal fins is 1.8.10⁻³°/W and its volume conductance 110 W/K.dm³.

The above considerations are immediately explained by the thermal conductivity of the materials concerned. Copper has a thermal conductivity of 380 W/m.K, aluminium 220 W/m.K and water 0.6 to at least 12 W/m.K, for a flow changing from laminar to turbulent. For polymers, which will be discussed below, the thermal conductivity is particularly poor: 0.22 W/m.K. The heat capacity of water is 4.18 kilojoules per kilogram and per degree, while that of dry air is 1 kJ/kg/K.

These same considerations apply to the radiators with solid metal fins, associated with water/air heat exchange coolers, intended for microprocessors and, more generally, to any component provided with a flat heat dissipation surface. In every case, the average residual difference in temperature existing between the outer faces of the fins and the air current which sweeps it is the one and only source of the cooling desired. It is therefore essential to increase it as much as possible.

### SUMMARY OF THE INVENTION

The first subject of the invention is an improved cooling device which is effective, not bulky, and inexpensive, which operates through heat exchange between a hot liquid and a cold fluid and which incorporates a finned radiator of a particular type, having a poor thermal resistance.

The second subject of the invention is such an improved cooler, in which water circulates in a laminar flow in the radiator.

The third subject of the invention is such an improved cooler which incorporates an original mini-heater, for a component with a flat heat dissipation surface, in which the water circulates in a laminar flow in the mini-heater and in the radiator.

The fourth subject of the invention is such an improved cooler for very high-performance microprocessors, comprising an appropriate mini-heater, provided with a heating plate exhibiting a particularly poor thermal resistance.

The fifth subject of the invention is such an improved cooler for very high-performance microprocessors, comprising an appropriate mini-pump, with hydraulic power, pressure and flow rate suited to the limited requirements of this cooler.

The sixth subject of the invention is such an improved cooler for very high-performance microprocessors, comprising an original component, formed by the combination of such an appropriate mini-heater and by such an appropriate mini-pump.

The seventh subject of the invention is an effective and inexpensive cooling device, for an internal combustion engine or a PEM-type fuel cell, which comprises a finned radiator of a specific type, in which the water circulates in a laminar flow.

The eighth subject of the invention is a supplementary cooling device for a diesel engine, intended to cool its exhaust gases in order to allow them to be used in order to improve the functions of this engine.

The invention provides an improved cooling device which is effective and inexpensive, operating through heat exchange between a hot liquid and a cold fluid, intended to be coupled to the heat dissipation surface of a given component concerned, or coupled by construction to this same surface, said component being intended to dissipate a given heat flow, situated in determined ranges of powers and temperatures, comprising:

a heater suited to said heat flow, comprising an internal cavity, provided with two manifolds, and a coupling surface corresponding to said heat dissipation surface;

a finned radiator, provided with two manifolds;

ducts for connecting together the manifolds of the heater and of the radiator and thus constituting a tight enclosure;

a hot liquid, in particular water, in this enclosure;

means for circulating, in a closed circuit, this hot liquid in this enclosure;

means for circulating this cold fluid, in particular air, between the fins of the radiator;

characterized in that:

said radiator is formed by one or more heat exchangers of a specific type, each constituted by a stack of hollow and thin fins, connected to two transverse manifolds.

In order to construct such a heat exchanger with hollow and thin fins, connected to two transverse manifolds, two techniques can be used. They both relate to a specific type of heat exchange element, which is remarkable in itself and by virtue of its method of production.

The first technique is described in European Patent Application No. EP 1 122505 A1, published in August 2001, filed by the Japanese company EBARA. This heat exchange element was developed in order to constitute the evaporator and/or the condenser of an absorption cooling device. It is formed by a stack of hollow plates, made from two superposed metal foils, in which regularly alternating depressions and projections, and two rimmed holes have been made beforehand. In order to form a hollow plate, two thus raised and pierced metal foils are attached to each other by welding of their outer edges as well as of the crests of their bosses and of the edges of their openings. Two adjacent hollow plates are attached to each other in a similar manner, in order to create an inter-plate space and to produce two transverse manifolds.

The second technique is described in the International patent application PCT, filed by TET, the proprietor of the present patent application, published in July 2004 under the No. WO 2004/055462 A1. A TET heat exchange active element is made in a single piece, without assembly or welding, formed by a stack of pairs of extended hollow thin plates, constituting hollow communicating fins, symmetrical overall, and if appropriate oblique, provided with two transverse manifolds, extended by two connecting tubes. This element is made in the following way:

(1) production, by heat blowing of a polymer or of a suitable glass or hydroforming of a metal of a suitable nature and shape, a blank constituted by a stack of bellows biconvex overall, comparable to those of an accordion, having corrugated walls and extended central parts, provided with end connections, preferably with fold-back surfaces, and with two connection tubes, centered on the stacking axes of the connections;

(2) this blank being at an appropriate temperature, an internal depression and/or external compression forces are applied, parallel to the stacking axes of its bellows, until the compressed part thus produced becomes a stack of pairs of fins which are hollow, communicating and symmetrical overall, if appropriate bistable and oblique, with small and approximately constant internal thickness and spacing;

(3) the single-piece part thus produced is left to cool, if necessary keeping it compressed in its final state.

These two types of heat exchanger are a priori suitable for any cooling device according to the invention. For small- or medium-power components, a single element is sufficient, which can comprise ten, twenty or thirty hollow EBARA fins or pairs of TET hollow fins, having a length of at most 20 cm. For powers of several kilowatts, these elements are used in a group (in parallel and/or in series), to form batteries, of several dozens if appropriate.

The use of an EBARA metal heat exchange element is, in principle, completely possible in the context of the present invention. In practice however, the complex technique for production of such an element and its high risk of leaks, due to the large number of waterproof welds that it comprises, may lead to rejects and high production costs as well as to replacements, which are a priori inevitable with use. This would prevent it from being adopted for any application involving large series at tight prices.

The use of a TET heat exchange element, generally made from polymer or glass and, in certain specific cases from a suitable metal, is perfectly suited, both for technical reasons and for considerations relating to the economy of manufacture and of use, to any cooling device according to the invention, operating through heat exchange between a hot liquid and a cold fluid.

According to the invention, in such cooling devices, said means for circulating the hot liquid are able, on the one hand, to generate a laminar flow of this liquid in the hollow fins of the radiator as well as, if appropriate, in the internal cavity of the heater and, on the other hand, to preferably circulate this liquid in counterflow to the cold fluid which circulates between these fins.

According to additional characteristics of a cooling device according to the invention,

in the case of hollow fins made of polymer or glass, the thickness of their walls is comprised between approximately 0.5 and 1 mm, and that of their internal channel, comprised between approximately 0.5 and 2.5 mm;

in the case of hollow fins made of metal, the thickness of their walls is comprised between approximately 0.2 and 0.5 mm, and that of their internal channel, comprised between approximately 0.5 and 1.5 mm;

in every case, the average difference between the fins is approximately 3 to 6 mm, when the cold fluid is air.

By means of the hollow and thin fins of the radiator of a cooling device according to the invention, the nominal flow rate of the water (it corresponds to the thermal power to be dissipated) in these fins is produced with laminar flow and yet the efficiency of the radiator is very high. This double result, apparently contradictory in the light of the above, is firstly fully justified and secondly it is advantageous for several reasons. A flow is laminar when the Reynolds number to be taken into account is low. And this number is proportional to the product of the hydraulic diameter of each of the hollow fins and the circulation rate of the water current concerned. The first term is low since it is more or less equal to double the average internal thickness of a fin, and the second is also low since it is equal to the nominal flow rate of water, corresponding to the heat flow to be evacuated, divided by the significant overall section of the stack of fins. Under these conditions, the thermal resistivity to be taken into account is that of water without any correction factor, but as the veins of water flowing are thin, the total thermal conductance of the water current is finally satisfactory. The same is true of the thermal conductance of the polymer walls of the fins which also have a high resistivity and a small thickness. Under these conditions, the temperature of the outer face of each fin is close to that of its internal face and it is the same at every level, from its root to its end. This produces, between the large total outer surface area of these fins and the air current which sweeps this surface, an average temperature difference equal to approximately 85% of that which exists between the water and air currents at the two inlets to the radiator. If the fins had been made of glass or in metal, this ratio would have been approximately 90 or 95%. Since this high average temperature difference causes the heat exchange to be carried out by the total large surface of the hollow fins, the efficiency of the cooler according to the invention is particularly great. This is even more clearly apparent, if it is compared to that of a conventional radiator having the same fin surface area, in which the rapidly falling temperature of these solid fins leads to an average fins/air temperature difference, almost three times less than that which is obtained with a hollow-finned radiator. To the above considerations it should be added that the water/air coupling, produced through the walls of the hollow and thin fins of a single-piece radiator is improved by the embossing of the walls (intended to give them an appropriate stiffness) which locally introduces slight reliefs and therefore some eddies in the air flow, which increases the apparent conductivity of this air.

As regards the various advantages provided by having both a laminar flow of the hot liquid in the radiator and a high efficiency of an improved cooler according to the invention, they appear in detail below, in the presentation of the various applications of the invention.

According to a first specific application of the invention, the water/air heat exchange cooling device of an internal combustion engine is also characterized in that:

the radiator comprises a group of heat exchangers with hollow and thin fins, mounted in parallel;

this group of exchangers is supplied with water by a pump and with air by a fan, so as to be passed over by the air and the water in counterflow.

According to an additional characteristic of the above, for an internal combustion engine installed in a motor vehicle, the radiator is split into two and formed by two groups of heat exchangers, mounted to the right and the left of the engine.

By means of these arrangements, a cooler according to the invention for an internal combustion engine of a motor vehicle, equipped with a single or split radiator with hollow and thin fins, makes it possible to obtain performances in various fields which are very much higher than those provided by a cooler with a conventional radiator, associated with an engine with the same power. In such a cooler, the frontal area of the radiator, the ventilation and water circulation power, the weight and the price of all of the components are greatly reduced, while the overall efficiency of the cooling is improved.

It will be noted that all of the above means and considerations apply without significant changes to the cooling of the bipolar plates of the PEM-type fuel cells, which must operate at a temperature of approximately 85° C., with a yield approaching 50%. When such a cell of several tens of kilowatts must be installed in a motor vehicle, this requires an efficient cooler which is not very bulky and is inexpensive, such as that according to the invention described above.

According to another specific application of the invention, a supplementary cooling device for a diesel engine, intended to produce cooled waste gases which can be used to improve the operation of this type of engine, is also characterized in that:

the heater is a heat exchanger with hollow and thin metal fins, installed in an appropriate chamber, arranged upstream of the usual expansion chamber of the waste-gas exhaust pipe;

the radiator is formed by several heat exchangers with hollow and thin fins, made of metal or glass, mounted in parallel;

a pump is adapted to circulate water in a closed circuit and in a laminar flow in the tight enclosure formed by the heater and the radiator;

a fan is adapted to circulate air between the hollow fins of the radiator, in counterflow to the water circulating in these fins.

In this supplementary cooler for a diesel engine, the second heat exchanger with hollow and thin fins no longer operates in a radiator as in the above case, but in a heater capturing the heat flow transported by the waste gases produced by the engine. Under these conditions, these very hot gases (>600° C.) are cooled under the same conditions as the cylinders of the engine and for example taken to 200° C. then cooled again during their expansion before their exhaust. At low and moderate engine speeds, an appropriate fraction of these greatly cooled gases can be removed then mixed with the air injected into the cylinders, in order to improve the operation of the diesel engines at these speeds and thus eliminate the production of effluents polluting the atmosphere. Another cooler for diesel engine exhaust gases is presented in the European Patent Application No. 2002 195106, filed by the Japanese company Hino Motors. This cooler comprises a heat absorber (not described), installed in a pipe for evacuation of part of the waste gases, connected via a heat transfer tube to a device (not described) for dissipation by radiation of this heat, installed close to the end of the pipe for escape of the gases. It constitutes the technological background to the supplementary cooler according to the present invention.

According to the characteristics of other applications of the invention, in a cooler with heat exchange between a hot liquid and a cold fluid, for components with a precision-ground flat heat dissipation surface,

the means for circulating the hot liquid, and in particular the water, can be natural convection, when an appropriate minimum vertical gap can be established between the orifices upstream of the mini-heater and of the radiator;

said appropriate minimum vertical gap is defined by the fact that it is capable of producing by thermosiphoning a nominal flow rate of the hot liquid which, on the one hand, corresponds to the heat flow to be dissipated in the installed radiator swept by the current of air available and which, on the other hand, maintains the maximum temperature of this liquid below a determined upper limit, specific to the component concerned;

the ducts of the internal cavity of the mini-heater exhibit, at a nominal flow rate of the liquid, a small pressure drop, compatible with a minimum thermal conductance sufficient for this mini-heater;

the manifolds upstream and downstream of the mini-heater as well as the connections linking the latter to the radiator orifices exhibit pressure drops which are as small as possible;

the hot liquid can then circulate either by simple expansion or mainly by production of a two-phase mixture of liquid and bubbles of vapor.

According to a supplementary characteristic of the above, in a cooler operating by natural convection, due to a simple expansion of the hot liquid,

the appropriate minimum gap between the orifices upstream of the mini-heater and the radiator is of the order of a decimetre;

the hot liquid circulating by natural convection is water at atmospheric pressure.

According to a variant of the above characteristic, in a cooler operating by natural convection, mainly due to a mixture of hot liquid and bubbles of vapor,

the appropriate minimum gap between the orifices upstream of the mini-heater and the radiator is of the order of a centimetre;

the hot liquid can undergo a liquid/vapor change of state, at a temperature at least a few degrees lower than the upper limit imposed on the component to be cooled;

said hot liquid is preferably water under low pressure or, if appropriate, a liquid having said property of changing state at atmospheric pressure.

By means of these last two possibilities, a whole range of means is available for the optimal use of an improved cooling device according to the invention. In order to illustrate this statement a description will now be given of what occurs, in each case, with a microprocessor and a cooler, according to the invention, which can be installed so as to have an appropriate vertical gap between the orifices upstream of its mini-heater and of its radiator. In order to do this, firstly a cooler having a minimum of sections constituting large pressure drop zones (in particular internal cavity of the mini-heater, restrictions and elbows of the connection ducts) is produced which limits the water flow rate to a value less than its nominal value. There is applied to the precision-ground heat dissipation plate of the microprocessor, a thin layer of paste with strong thermal conductivity, then the precision-ground thermal coupling surface of the mini-heater. By necessity, this mini heater has a high thermal conductance, which will be the subject of supplementary considerations later. Then, the mini-heater and the chosen radiator are installed vertically and the latter is exposed to the available air current.

Firstly, the tight enclosure of the cooler contains a liquid which is capable of boiling, at a temperature a few degrees lower than the maximum temperature which the microprocessor can tolerate. Such a liquid operates at low pressure or at atmospheric pressure. In the first case, this is preferably water (at 300 hPa, water boils at 60° C.) and, in the second, ether (30° C.), methanol (60° C.), or ethanol (78° C.), for example. Under these conditions, a small vertical gap, at least of the order of a centimetre, between the orifices upstream of the mini-heater and of the radiator with hollow fins, makes it possible, without using a pump, to carry out a satisfactory dissipation of high flows of heat, emitted through the small thermal dissipation plate of a microprocessor. This occurs, by means of the circulation by natural draught of a two-phase heat transfer mixture, formed by a liquid and by bubbles of its vapor. It will be noted that, by contrast to the free state of the vapor produced in the known coolers mentioned above, these bubbles of vapor remain constantly trapped in the hot liquid. The efficiency of this arrangement is due to the exceptionally high apparent expansion coefficient of such a liquid-vapor mixture. When the temperature of the liquid passes its boiling point and the heat flow is maintained or increases, bubbles of vapor are produced which cause an increase in volume of the mixture much greater than the expansion of the liquid itself. The average density of the water-bubbles mixture, contained in the mini-heater, can then fall to 80%, for example, of that of the liquid water. These bubbles of vapor and the liquid portions which surround them are subjected to a considerable upwards thrust in the mini-heater and in its downstream manifold (approximately 20 Pa/cm). Through thermosiphoning, this makes them rapidly pass through the internal cavity of the mini-heater and its downstream manifold, to arrive at the orifice of the manifold upstream of the radiator.

As they pass the hollow and thin fins of the radiator from the top to the bottom and at reduced speed, these bubbles of vapor and these portions of liquid exchange heat with the air current, through the fine walls of these fins. This air current, at an initially low temperature (25° C., for example) circulates from the bottom to the top along the outer faces of the walls of the hollow fins of the radiator. Upon leaving the radiator, at the end of this counterflow heat exchange, most of these bubbles of vapor have disappeared, dissolved in the liquid water, or been reduced in volume, due to the condensation of part of the vapor which constituted them. For its part, the latent heat of condensation released at this point is totally carried away by the air current, by means of the good thermal conductance of the thin stream of water circulating in the hollow fins of the radiator and the thinness of the walls of these fins. At the outlet from the radiator and at the inlet to the mini-heater, the average temperature of the mixture of water and bubbles of vapor is 15 to 20° C. higher than that of the air which penetrates between the fins of the radiator, and the average density of this mixture is increased by approximately 20%. At the top of the cooling device, the temperature of the air has greatly increased to end up only a few tens of degrees below the initial average temperature of the liquid-vapor mixture. It will be noted that if the circulation of the air between the fins of the radiator was reversed (from the top to the bottom instead of from the bottom to the top), the heat exchanges would take place co-currently. This is still useful, due to the increase in the heat exchanges then carried out in the upstream part of the radiator.

If in such a short cooler, installed vertically, the liquid with a low boiling point is replaced with water under an atmospheric pressure of non-condensable gas which is stable well beyond the fixed upper temperature limit, the expansion that this water undergoes, in response to a given heat flow, produces a much lower flow rate circulating by natural draught. This leads to a significant decrease and finally an insufficient amplitude of the heat flow exchanged between the water and the air, through the wall of the radiator. Consequently, with water under an atmospheric pressure of a non-condensable gas, a larger vertical gap (at least of the order of a decimetre) is necessary, between the orifices upstream of the mini-heater and the radiator. Under these conditions, by means of a chimney effect, the draft is increased and the flow rate of water circulating by thermosiphoning then reaches a sufficient value for the amplitude of the heat exchanges carried out to return to complete conformity with what is sought.

Moreover, for the cooling of various types of components, installed in any device, if an appropriate heater and radiator are used, with upstream orifices sufficiently separated from one another along the vertical, it is possible to make it a system without a moving part. When installing vertically, the heater inside the device and the radiator outside, if appropriate, at the base of a stack of appropriate height, when the thermal power to be dissipated is several kilowatts, the circulation of water (or of a water-bubbles mixture) in the hollow fins as well as the circulation of air between these fins can, in certain cases, take place simply by natural convection, for water and for air. A fan with reduced power can, if appropriate, provide all of the flow rate of air necessary, in the case of a high ambient temperature for example. Completely satisfactory heat exchanges can then be obtained between the water and the air. This considerably reduces the cost of the installation.

When the mini-heater and the radiator of a cooler according to the invention cannot be installed vertically in the device incorporating the component to be cooled, a pump is then necessary in order to circulate the cooling liquid, as with the conventional radiators with solid fins. However the pumping power is then much lower. And despite the requirement for such a pump, it is nevertheless the case, as will be seen below for the microprocessors installed in a small laptop or desktop computer, that in numerous fields the reduced bulk, the great efficiency, the longevity and the low cost of a radiator with hollow and thin fins made of polymer, allow it to be advantageously used in many respects.

According to another characteristic of the invention, in a cooling device with heat exchange between a hot liquid and air, for components with a flat and precision-ground heat dissipation surface;

the heater is a mini-heater, perfectly suited to its function, which comprises a heating plate, made of metal with high thermal conductivity, and a rigid hose made of moulded polymer;

the heating plate is provided with an outer precision-ground coupling face, corresponding to said heat dissipation surface, and an initially flat internal face, the central part of which has parallel grooves sunk in it, with dimensions, pitch and number which are determined by the density and the intensity of the heat flow to be dissipated;

the hose incorporates two upstream and downstream manifolds, opening on either side of a flat rectangular central zone of its internal face;

the heating plate is fixed in a tight manner to the internal face of the hose;

said flat rectangular central zone of the hose is applied to the central part of the grooved internal face of the heating plate, so as to serve as a lid and thus constitute the internal cavity of the mini-heater and clear the orifices of this cavity.

According to supplementary characteristics of the above, since the component concerned is a very high-performance microprocessor, the precision-ground heat dissipation plate of which comprises a small very hot central zone,

the width of the grooves of the heating plate is as small as possible, i.e. less than approximately 0.2 mm, their depth is, as a decreasing function, approximately ten to fifteen times this width, and their pitch approximately two times;

the grooved central part of the internal face of the heating plate projects well over said small very hot central zone of the microprocessor;

the thickness of the heating plate is approximately two times the depth of the grooves;

a pump is used in order to circulate the hot liquid.

According to a variant of the above characteristics, the component concerned being a high- or average-performance microprocessor, the precision-ground heat dissipation plate of which comprises a slightly hotter central zone,

the width of the grooves of the heating plate is comprised between approximately 0.5 and 1.5 mm, their depth, as a decreasing function, is approximately five to eight times their width, and their pitch is approximately two times;

the grooved central part of the internal face of the heating plate projects well over said hotter central zone of the microprocessor;

the thickness of the heating plate is approximately half the depth of the grooves;

the manifolds of the mini-heater are in alignment with the grooves in the heating plate;

thermosiphon means can be used in order to circulate the hot liquid.

By means of these arrangements, by adjusting the geometry and the pitch of the grooves of the heating plate, it is simple to produce, between the lid, constituted by the central zone of the internal face of the hose, and the bottom of the grooves of the internal face of the heating plate, an efficient mini-heater internal cavity, corresponding to the requirements of the cooling envisaged. To this end, this cavity is formed by micro or mini-channels, with a hydraulic diameter corresponding to that imposed by the maximum local density of the heat flow to be dissipated and by its total intensity. In other words, this hydraulic diameter is determined by the nominal local flow rate desired and by the minimum thermal conductance necessary, which can be provided just above said very hot or hotter zone of the microprocessor. Moreover, the laminar flow produced in these mini or micro-channels takes place with a very small pressure drop.

When the intensity of the heat flow to be dissipated through the small very hot zone of the dissipation surface of the microprocessor, is greater than approximately 150 W and its density than approximately 100 W/cm², the grooves of the heating plate are very fine and a pump is used. When this intensity and this density are lower, these same grooves are wider and thermosiphon means can be used in order to circulate the hot liquid. In both cases, the thickness of the heating plate is determined, in order to correctly provide an efficient diffusion of the heat between the very hot or hotter central zone of the dissipation plate of the microprocessor and all of the surface of the grooved central part of the internal face of the heating plate.

In order to provide an optimum circulation by thermosiphon of the hot liquid or of a liquid-bubbles of vapor mixture, in such a cooler, the cross-section of the upstream and downstream manifolds of the mini-heater and that of their orifices should be at least equal to the total section of its mini-channels, the elbows connecting the ends of the micro-channels and the manifolds must be as open as possible and the axes of these two manifolds are situated on the same line as the groove or the central fin of the heating plate. This is in order to prevent the presence of restrictions and elbows which generate pressure drops which would limit the flow rate of the water. By contrast, when the circulation of the hot liquid must be achieved by pumping, the axes of the upstream and downstream manifolds of the mini-heater are preferably perpendicular to the grooves of the heating plate. In the case of a mini-heater associated with a commercially available pump this makes it possible to reduce the space requirement.

According to the invention, a water/air heat exchange cooling device, for a microprocessor, comprising a radiator with hollow and thin fins, an appropriate mini-pump and a mini-heater, is characterized in that:

this appropriate mini-pump comprises a brushless electric motor, provided with a rotor, in the form of a roller with a single diametral magnetization, and a centrifugal turbine integral with this rotor;

the body of this mini-pump comprises a cylindrical cavity, provided with a tight lid;

the rotor-turbine assembly is enclosed with a slight clearance in this cavity;

the rotor-turbine assembly is rotatably mounted on a shaft turning in two small depressions, made in the bottom of this cavity and in the internal face of this lid;

the turbine is constituted by radial vanes arranged in a ring on a disk;

a water inlet duct is provided in the lid and opens into the center of this ring;

a water outlet opening is provided in the wall of the cavity, at the level of the turbine vanes;

two parts, diametrically opposite the wall of said cavity, are cylinder portions with a thin wall and the poles of the stator of the electric motor fit against these wall parts;

the stator of the electric motor comprises a winding supplied by an electronic circuit, which is adapted to start the motor then making it rotate up to an appropriate speed.

By means of these arrangements, it is possible to construct an appropriate mini-pump, corresponding exactly to the very limited requirements of a laminar flow water cooler, for a microprocessor. With a roller with single diametral magnetization, with a diameter of 3 cm and a thickness of 3 mm, the yield of such a brushless electric motor can approach 10% and the power consumed can be 2 W, in complete safety. The well known technologies of the various types of brushless electric motors, which are capable of being used in the context of the present invention, will not be discussed here. With a turbine with eight radial vanes which are 1 cm long and 3 mm high, rotating at 50 revolutions per second, the hydraulic power provided can reach 100 mW (hydraulic pressure: 100 hPa, nominal flow rate of water 10 g/s).

According to the invention, the hose of the appropriate mini-heater and the body of the appropriate mini-pump, described above, are the two juxtaposed parts of the same block made of rigid moulded polymer, so that this mini-heater and this mini-pump together constitute an original component, in which the inlet to the upstream manifold of the mini-heater and the water outlet from the mini-pump are merged, the upstream manifold of the mini-pump and the downstream manifold of the mini-heater are respectively the upstream and downstream manifolds of this component and the latter two manifolds are perpendicular to the grooves of the heating plate.

By means of these arrangements, a novel component is produced which is compact, light and inexpensive, which can be easily placed in the cooler of a laptop or desktop computer of small dimensions. In addition to these advantages, such a component makes it possible to connect together the mini-pump and the mini-heater, with a minimum of risk of leaks and a minimum of pressure drop.

The characteristics and advantages of the invention will become apparent in a more precise manner from the following description of cooling devices for various types of components concerned, given by way of non-limiting examples, with reference to the attached drawings.

### BRIEF DESCRIPTION OF THE DRAWINGS

FIG. 1 is a sectional view along the longitudinal plane of symmetry CC′ (see FIG. 2) of a water cooler for a microprocessor with average performance, in which the water circulates by thermosiphon;

FIG. 2 is a view according to the cutting plane AA′, represented in FIG. 1;

FIG. 3 is a view according to the cutting plane BB′, represented in FIG. 1;

FIG. 4 is a schematic view of a diesel engine of an automobile, equipped with a water cooling device according to the invention and a supplementary waste-gas cooling device;

FIG. 5 is a schematic view of a water cooler for a microprocessor;

FIG. 6 is a longitudinal sectional view of an original component, comprising a mini-heater and a mini-pump, of such a water cooler, for a very high-performance microprocessor;

FIG. 7 is a top view of this component.

### DETAILED DESCRIPTION OF PREFERRED EMBODIMENTS

According to the first three figures, a cooling device 10, according to the invention, is installed vertically. It is coupled and fixed, by any appropriate means, to a microprocessor 12, capable of generating a thermal power of 120 Watts. This heat flow must be evacuated through a square precision-ground plate 14 for thermal dissipation, with sides of 35 mm (i.e. an average density of 10 W/cm²), so that its average temperature remains less than 70° C. for example. The cooler 10 comprises a mini-heater 16, a rigid hose 18, a radiator 20, a jacket 22 and a fan 24.

The mini-heater 16 is formed by a copper heating plate 17, applied to the hose 18. This heating plate 17 has a total thickness of 10 mm and it has an outer thermal coupling face 26, which is square and precision-ground and has 35 mm sides, connected by two inclines at its fixing edges 28-30, 10 mm wide, as well as a bottom 2 mm thick and side walls 1 mm thick. The internal face 31 of this heating plate 17 comprises eleven parallel grooves 32₁₋₁₁, which are 1.5 mm wide, 40 mm long and 8 mm high, in their central part, as well as ten fins 34₁₋₁₀ with a thickness of 1 mm. The ends of these fins 34 and of these grooves 32 have circular arc profiles and the distance between their end edges is 60 mm. The outer coupling face 26, of the heating plate 17, fits against the dissipation plate 14 of the microprocessor, through a fine layer of paste with high thermal conductivity (not shown). The edges 28-30 of the heating plate 17 are applied and fixed by screws, in a tight manner (flexible seal) on the hose 18. This hose 18 is made of rigid polymer and its central part 36 comprises a concave outer face and a rectangular internal face 35, 30 mm long and 27 mm wide, which is adapted to bear on the tips of the fins 34₁₋₁₀ and on the two lateral edges of the plate 17. As a result, this internal face 35 of the hose 18 constitutes the lid of the central parts of the grooves 32₁₋₁₁ and delimits, just above the curved bottoms of these grooves, the substantially rectangular orifices, downstream 38 and upstream 40, of the mini-heater 16. The upstream 42 and downstream 44 manifolds of the mini-heater 16, also arranged in the hose 18 are connected to these orifices. The cross-section of these orifices is at least equal to the total section of the mini-channels, formed by these grooves and their lid, which together constitute the internal cavity of the mini-heater 16. The upstream manifold 42 is a short duct 2.5 cm in length, having a circular inlet orifice 50, connected to the downstream connecting tube 46 of the radiator 20, and a rectangular outlet orifice 40 which constitutes the upstream orifice of the grooves 32₁₋₁₁. Similarly, the manifold 44 is a duct 7 cm in length, having a rectangular internal orifice 38, connected downstream of the grooves 32₁₋₁₁, and another circular outer orifice 52, connected upstream orifice 48 of the radiator 20. The vertical gap between the axes of the upstream orifices 40 and 48 of the mini-heater 16 and the radiator 20 is 12 cm. The mini-heater 16 and its two manifolds 42-44 have the same plane of symmetry, which crosses lengthwise the central groove 32₆ of the internal face 31 of the heating plate 17. The manifolds 42-44 are connected to the connecting tubes 46-48 of the radiator 20, by horizontal ducts which are as short as possible (not shown). The upper end 53 of the hose 18 comprises a boss 57, provided with a small opening intended to allow the enclosure to be filled and then to be sealed. The outer orifices 50-52 of the manifolds 42-44, their optional connection ducts and the connecting tubes 46-48 of the radiator 20, are connected to each other by any appropriate means, in particular collars, welds or bonds.

The radiator 20 is a single-piece heat exchange element with hollow and thin fins, made of optionally carbonated high density polyethylene. It is represented with eight pairs of hollow fins 56 separated by spaces 58. In fact, the radiator 20 comprises fifteen pairs of fins, in order to be able to easily evacuate 120 W. These fins represented obliquely result from turning back one of the flanks of the biconvex bellows of the initial blank and in FIG. 3 together, they look like a vertebral column of a fish. These fifteen pairs of fins have a total height of 17 cm, a gap of 12 cm between the axes of their connecting tubes 46-48, a width of 5 cm and a total thickness of 9 cm, with a stack pitch of 6 mm, walls of 0.5 mm on average, average internal thicknesses of 1 mm for the channels of the hollow fins and of 4 mm for their separation spaces 58. The volume of this radiator 20 is approximately 0.7 dm³. It will be noted that the HD polyethylene charged with an appropriate additive becomes, in the extruder used in order to produce the blank of this radiator, a particularly fluid paste which makes it possible to obtain a great thinness of walls. The two hollow fins 56₁₋₂ of a pair are connected to each other by a portion of the central channel 60 of the single-piece element 20. The ends of this central channel 60 constitute for the fins 56, two transverse manifolds 62-64, extended by the connecting tubes 46-48.

The tight enclosure in the form of a looped circuit, constituted by the mini-heater 16, the ducts 42-44 of the hose 18 and the radiator 20, contains distilled water at atmospheric pressure. This water is introduced into this enclosure through the opening in the boss 57, its final level approximately corresponding to the axis 49 of the top connecting tube 48 for connection to the radiator 20.

The jacket 22 can be formed by two shell-shaped sections, with the edges fixed to each other by any appropriate means (see the PCT Application concerned). An opening is made in each of these sections, in order to permit passage and to serve as a fixed support for the two connecting tubes 46-48 of the heater 20. The walls of the jacket 22 are close to the ends of the hollow fins 56 of the radiator 20 and its orifices 66-67 are wide. At the end of the bottom orifice 66 of this jacket 22, a ring 68 is installed which serves to support the attachment arms (not shown) of the fan 24 equipped with a propeller 25. This fan 24 is adapted for producing an air flow rate of at least 10 litres/second.

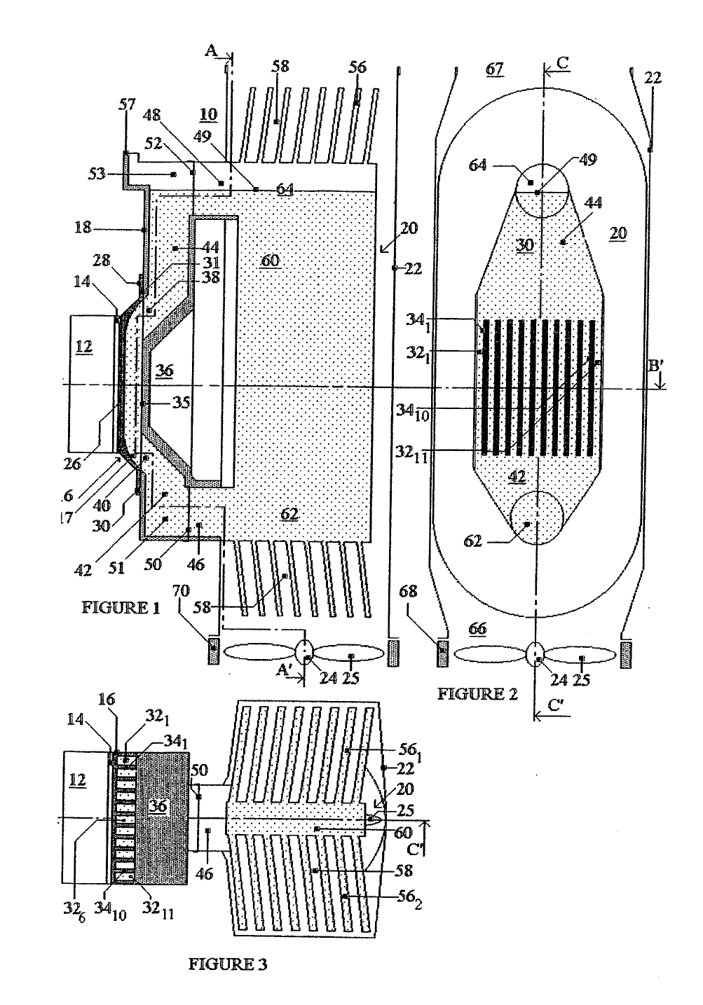

By means of the fins for thermal distribution of the heating plate 17 of the mini-heater 16, the effective heat exchange surface area between the thermal dissipation plate 14 of the microprocessor 12 and the water contained in the numerous channels 32 of this mini-heater 16, is in practice multiplied by six. Under these conditions, the heat flow to be dissipated (120 W), which produces an average density of 10 W/cm² on the coupling face 26 of the heater 20, results, for the channels 32 filled with water, in an average density of 1.7 W/cm², produced by the fins 34, the bottom and the walls of the mini-heater 16. The difference between the average temperatures of the dissipation plate 14 and the water in the mini-heater 16 is approximately 6° C., i.e. for the heating plate 17, a thermal resistance of 0.05°/W. The expansion of the water following its rise in temperature creates, between the upstream orifices 40-48 of the mini-heater 16 and the radiator 20, a thrust by natural convection, which circulates the water with a flow rate a little less than 3 g/s, directly determined by all of the pressure drops in the closed circuit of the cooling device 10. When passing over the hollow-finned radiator 20, the pressure drop of the water current is limited to a few Pascals and its temperature changes from 60 to 50° C., which corresponds to the desired evacuation of the 120 W to be dissipated. For its part, the current of ambient air enters the jacket 22 at 35° C. and it leaves it at 45° C., which corresponds to an air flow rate of 12 g/s (or 10 litres per second at 35° C.) between the hollow fins of a radiator 20. The water enters the heater 16 at 50° C. and leaves it at 60° C., which causes the temperature of the upper edge of the thermal dissipation plate 14 of the microprocessor 12 to be maintained at a maximum value of 66° C., given the thermal resistance existing between this plate 14 and the water which must cool it. The total thermal resistance of such a radiator 20, passed over in counterflow by water, at an average temperature of 55° C., and by air, at 40° C. average temperature, is 0.125°/W. The total thermal resistance of the cooling device according to FIG. 1, in which the water circulates without a pump simply by natural convection, is therefore 0.175°/W. The radiator 20 and its jacket 22, equipped with a fan 24-25, can be installed inside the device and, in this case, the air enters it warm (40°). As an advantageous variant, the air can be drawn directly from the outside of the device, at a temperature of 25° C. for example, which reduces the total thermal resistance of the cooler without modification of the radiator 20. Another variant involves arranging the radiator 20 outside the device and installing it in a duct of appropriate height, functioning as a stack (>15 cm). In this case, the external air enters it from the bottom and rises in it by natural convection, assisted or not by a low-powered fan. When the flow rate of air sweeping the fins is thus reduced, it must be compensated for by an increase in the number and/or the length of fins of the radiator, proportional to the reduction factor of this flow rate. Such an arrangement is suitable for the economical cooling of high powered electronic circuits.

In the case where, because of the maximum space requirement allowed in a device of small dimensions, the gap between the orifices 40-48 upstream of the mini-heater 16 and the radiator 20 would be limited to 5 cm for example, the flow rate by thermosiphon of water at atmospheric pressure, in the closed circuit of the cooler, would not be sufficient to evacuate the heat flow concerned. In order to solve this problem, the radiator 20 is made of a metal or an appropriate polymer, so as to be significantly more rigid than the one with fine walls described above. Water is introduced, under an air vacuum or expanded at 100° C. and atmospheric pressure, into the enclosure of the cooler 10, then the enclosure is immediately sealed. As a result, bubbles of vapor appear in this water which has become water at reduced temperature and low pressure, as soon as a heat flow penetrates the mini-heater 16. Under these conditions, the flow rate of the water-bubbles mixture produced can reach at least that of the liquid water previously obtained with a radiator having a 12 cm gap approximately between the axes of the upstream orifices 40-48. In this case, the initial and final temperatures of the water and the air specified above are barely modified for an identical heat flow. As in the previous case, the radiator 20 can be installed inside or outside the device.

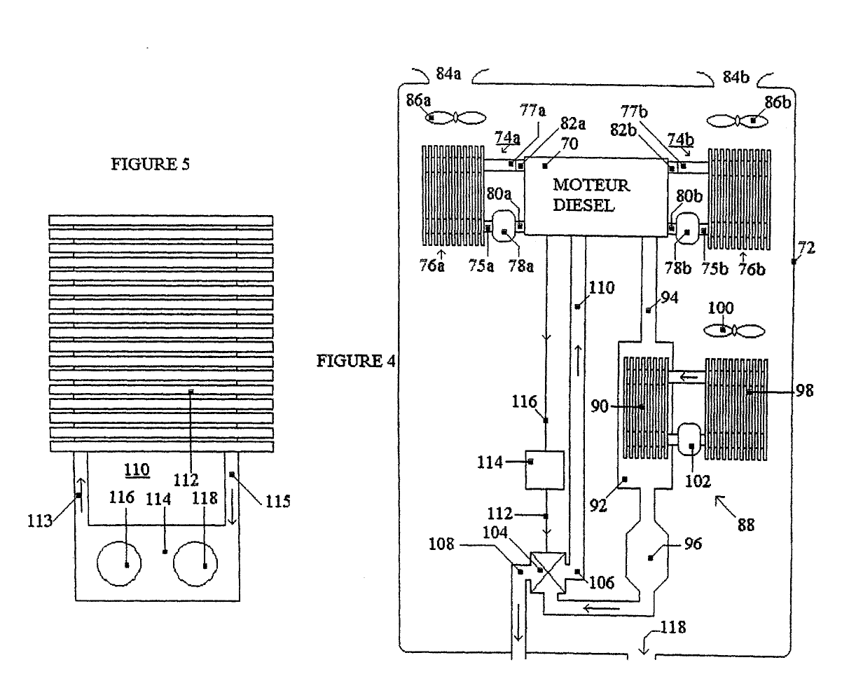

According to FIG. 4, a diesel engine 70 generating 30 kW of mechanical power, is installed in a motor vehicle 72 and is equipped with a duplicated cooling device, which comprises two identical assemblies 74 a-b, installed to the right and to the left of the engine 70. Each cooler 74 a-b comprises a group 76 a-b of five single-piece heat exchangers, with twelve pairs of hollow and thin fins made of polypropylene, mounted in parallel. The fins of these exchangers have 1 mm internal thickness, 0.5 mm wall thickness, 3 mm gaps and 15 cm depth and each exchanger has a front surface area 5 cm wide and 6 cm long. The total front surface area of the ten exchangers is 6 dm² and their total volume 9 dm³. Each group 76 a-b has upstream 75 a-b and downstream 77 a-b manifolds and it is supplied by a pump 78 a-b, connected to the two terminal connecting tubes 80 a-b of the hose downstream of the engine 70. The cooling water exits from the jacket of the cylinders of the engine 70 at 80° C. and its flow rate is 1.5 dm³/s. As a variant, a single pump can be installed upstream of the connecting tubes 80 a-b. At the outlet from the exchangers 76 a-b, the water follows one of the two connecting tubes 82 a-b of the hose upstream of the engine 70, to return cooled to 75° C. into the jacket of the cylinders of the engine. Behind two air vents 84 a-b, arranged at the front of the vehicle 72, and in front of each of the groups 76 a-b of heat exchangers of the split radiator, a fan 86 a-b is installed. The air is blown into the inter-fin spaces of the exchangers, in counterflow to the water which circulates in these hollow fins.

According to the other part of FIG. 4, the heater of a supplementary cooling device 88, intended to cool the waste gases produced by the diesel engine 70, is constituted by a single-piece heat exchanger 90, with hollow and thin metal fins of appropriate dimensions and shape. This heater 90 is installed in a cooling chamber 92, inserted into the exhaust pipe 94 of the engine 70 and arranged upstream of the usual expansion chamber 96 comprised in such a pipe. The heater 90 is connected to a radiator 98 formed by a group of heat exchangers, with hollow and thin metal fins, mounted in parallel, downstream of a fan 100. A pump 102 circulates water under boost pressure, in the enclosure formed by the heater 90 and the radiator 98, in cocurrent with the waste gases leaving the engine 70 for the heater 90 and in counterflow to the air blown by the fan 100 for the radiator 98. Downstream of the expansion chamber 96, there is installed a by-pass valve 104 with two outlets 106 and 108, the first to a duct 110 returning to the diesel engine 70 and the second to the outside. The by-pass valve 104 operates in response to an appropriate electrical command which is adapted to make it direct a greater or smaller fraction of the flow of waste gases towards one or the other of these two outlets 106-108. This appropriate electrical command reaches the valve 104 via a connection 112 and it is processed by a digital calculation circuit 114, programmed for this purpose, which receives from the diesel engine 70, via a connection 116, a signal representative of the speed of this engine. The window 118 symbolizes the openings for evacuation of the air blown in the same direction by the fans 86 a-b and 100 then reheated by the radiators 76 a-b and 98.

The heat flows carried off by the two flows of cooling water of the cylinders of the diesel engine 70 and of its waste gases being of the same order of magnitude as the mechanical power of the engine (30 kW, in the example), the single-piece heat exchangers constituting the heater 98 and the radiator 90 of the supplementary cooling device of the engine 70 have thermal resistances substantially equal to the result of the comparison of those of the radiators 76 a-b of the duplicated cooling device 74 a-b of this engine 70.

By means of these arrangements, the cooling device 74 a-b, equipped with a radiator with hollow and thin fins according to the invention, associated with the engine 70 of a motor vehicle 72, makes it possible to obtain results which are much more advantageous in every respect than with a cooling device equipped with a standard radiator with solid metal fins. In the case of a vehicle with an internal combustion engine (diesel or gasoline), the water circulates in the jacket of the engine cylinders, in a not very turbulent flow sufficient to carry off a heat flow at more than 600° C., more or less equal to the mechanical power generated. Then, it circulates in a laminar flow in the hollow fins of the split radiator 76 a-b. The average temperature of the water must be situated between 80 and 90° C., as a function of the instantaneous power required of the engine and of the temperature of the surrounding air. In order to do this, the cooling device 74 a-b according to the invention, of the 30 kW engine 70, dissipates in the external air a heat flow of the same value, with a flow rate of water of 1.5 dm³/s and a permanent difference of 55° C. between the average temperatures of the water and the air. This is obtained with a split radiator having the same total thermal resistance of 1.8,10⁻³°/W as with the radiator with solid fins mentioned above, but with a total fin surface area reduced to 3.7 m² (instead of 10), a front surface area reduced to 6 dm² (instead of 17), a total volume increased to 9 dm³ (instead of 5), an air flow rate limited to 1275 g/s (instead of 2000), an aerodynamic power of 2.3 kW and a volume conductance of the radiator of 61 W/K.dm³ (instead of 110). As regards the increase in the air temperature, as it passes over the radiators 76 a-b, it is 23.3° C. (instead of 15° C.) and the reduction in that of the water is 4.8° C. (instead of 3° C.).

For the same thermal power dissipated in the air and a volume conductance reduced by 45%, its front surface area (frontal area) is reduced by a factor of approximately three if the flow rate of air which previously passed over the standard radiator is preserved. In practice, the air flow rate and pressure drop values in the radiator are fixed, as a function of the maximum speed of the air current (relative wind of the vehicle and/or fan) and the specifications of the radiator are deduced from this, as a function of the thermal power to be dissipated in air at a given temperature. Starting with the front surface area thus determined for the hollow-finned radiator to be used, the number and the pitch of these fins and then the width and thicknesses of their walls and internal channels are deduced from these specifications. Under these conditions, the dissipation of significant heat flows (up to at least 100 kW) produced by the internal combustion engines can be obtained, by adjusting by a greater or smaller amount the total volume of the radiator and the parameters pertaining to the fins, listed above. This takes place as a function in particular of the maximum acceptable front surface area, the hydraulic power of the pump, the aerodynamic power required at low speed in the uptake pipes or the maximum increase tolerated for the temperature of the air at the outlet from the radiator. Under these conditions, a cooling device according to the invention can be produced, so as to be able to perfectly satisfy all of the specifications fixed by the engineers who design new motor vehicles.

The cost of such a single or duplicated radiator, made of a suitable polymer is in particular less than that of an equivalent standard radiator. Moreover, although the thickness of a hollow-finned radiator is several times that of a radiator with solid fins, because it is determined by the length of these fins, this poses no particular problem because there is generally a large amount of space behind the radiators. This justifies the small relative reduction in the volume conductance of the new radiator. Moreover, as the maximum temperature of the cooling water of a standard motor vehicle internal combustion engine is situated between 80 and 90° C., the polymer suitable for use in the production of the radiator can be high-density polypropylene or polyethylene, both inexpensive products. As regards the use of a split radiator instead of a single one, this is justified by the fact that it provides a certain security in the case of an accident and generally facilitates the optimum positioning of these engine accessories. In the hollow-finned radiators of the cooling devices 74 a-b, the air and water currents circulate in opposite directions along the fins, which increases their thermal coupling, if compared to what is produced by the cross currents which are found in the standard radiators with solid fins. To these thermal results it is necessary to add a very strong reduction in the pressure drop of the water current in the hollow-finned radiators which, in the case of the example, becomes less than some hundred Pascals. This makes it possible to significantly reduce the total power of the pumps 78 a-b. All this demonstrates the numerous technical and economic benefits of two radiators with hollow and thin fins, made of a suitable inexpensive polymer, in a water/air heat exchange cooling device, for any motor vehicle internal combustion engine.

All of the above considerations can be easily transposed to the case of motor vehicles driven by an electric motor, supplied by a PEM-type fuel cell. Such a cell comprises a stack of cells which are each formed by a proton-conducting polymer membrane (in particular that sold under the trade mark Nafion® by Dupont de Nemours) and an oxidation catalyst film (platinum), sandwiched between two permeable electrodes. Between two electrodes of opposite signs belonging to two neighbouring cells, a bipolar plate is arranged, with high electrical and thermal conductivities and provided with grooved faces. These grooves constitute ducts intended to ensure the hydrogen supply to the anode of the membrane of a given cell, the air supply to the cathode of the membrane of an adjacent cell and the evacuation of the water vapor produced. In certain embodiments of these bipolar plates, their center section is passed over by numerous parallel mini-channels, which the cooling water of the cell is intended to run through. For this purpose, they are often made of a highly conductive material which is easy to machine, for example graphite. The membrane operates at a maximum temperature comprised between 80 and 85° C., with an maximum average yield of approximately 50%. This again creates the need for an acceptable efficient cooling device. Each cell generates a voltage of approximately 0.8 volts and an electrical power of at most 0.4 W/cm², i.e. with a surface area of 25 dm², a power of the order of a kilowatt. Under these conditions, the density of heat flow to be evacuated by the heat dissipation zone of each bipolar plate is approximately 0.4 W/cm², which is very low.

By contrast, the thermal resistance per square centimetre, inserted between the faces of the electricity-generating membrane and the water which runs through the cooling mini-channels, is relatively high. This is the result of the inevitably small thermal coupling which exists between the faces of this membrane, the permeable electrodes (fine meshes) and the bipolar plates with grooved faces of each cell. The thermal resistance of the mini-heater, thus constituted in the bipolar plate associated with the membrane, produces, whatever the surface area of this plate an average temperature difference of approximately 5° C., between the cathode of this membrane and the water which circulates in the cooling mini-channels. The maximum temperature of this water at the outlet from the mini-channels is at most 80° C.

By way of example, a 30 kW PEM-type fuel cell, under 50 V, constitutes a block of approximately 40 dm³, formed by a stack of sixty four cells having 4×3 dm² faces and a thickness of 5 mm. In order to evacuate 30 kW, with an increase in temperature of 10° C., the flow rate of the water must be 720 g/s. Evacuation of these 30 kW, carried off by this water flow rate, in a hollow-finned radiator where it loses 10° C., requires for example an air current of 0.75 kg/s which is heated up by 40° C. as it passes through. With an ambient air at 25° C., the outlet temperature of the air is 65° C. and the average temperature difference between the water and the air 30° C. The thermal resistance of the radiator should consequently be 10⁻³°/W.

Such a thermal resistance is obtained by means of two groups of hollow-finned thermal exchangers three times larger than the two groups 76 a-b, used for the cooling of an internal combustion engine 70 with the same power. The front surface areas of each group are therefore 9 dm² and the total surface areas of its fins 5.6 dm². This is very remarkable if they are compared, on the one hand, to that of a standard single-piece radiator with solid fins (17 dm²), commonly used for evacuating the heat flow of a 30 kW heat engine and, on the other hand, to that, three times greater (51 dm²), of the single-piece standard radiator, which must be used to cool a 30 kW PEM cell. Such an increase in surface area results from conditions of hydraulic power at the upper limit, which must be imposed on the water circulating in the fragile mini-channels for cooling the cells and, consequently, from the limited speed and pressure which result therefrom for this same water circulating in a standard radiator.

As regards the maximum ventilation power necessary (fan and relative wind), it is approximately 1 kW, i.e. 3% of the power output. Moreover, with a total flow rate of water of 0.72 dm³/s in the hundreds of mini-channels for cooling this cell, the speed of the water in each is very slow. This causes it to circulate in laminar flow in these mini-channels, as in the hollow fins of the radiator. Consequently the power of each of the two pumps is relatively low (of the order of 5 hydraulic W, i.e. approximately twenty mechanical Watts), the total pressure drops in the mini-channels of the bipolar plates of the cell and in the hollow fins of the radiator each being at most approximately twenty hectopascals. The cooling device according to the invention associated with a PEM-type fuel cell, installed in a motor vehicle, makes it possible to solve, under advantageous technical and economic conditions, the problem posed by the dissipation of a very high heat flow, produced at low temperature and transferred to a water current circulating with a flow rate at an upper limit.

In the supplementary cooler system 88 associated with the diesel engine 70, the heat exchangers 90 with hollow metal fins no longer operate as a radiator as in the previous case, but as a heater collecting the heat flow carried by the waste gases of the engine. The design implemented in the present case is symmetrical to that used in the preceding case. With such metal heat exchangers which are efficient, inexpensive and compact, such an installation becomes technically and economically possible. A heat exchanger, with hollow and thin metal fins, can easily tolerate the high temperature of the waste gases of the engine (>600° C.). These gases penetrate into the exhaust manifold 94 and they can firstly be cooled in the chamber 92 to a relatively low temperature, for example 200° C. with water under boost pressure and the metal radiator 98. In the hollow fins of the heater 90 and between these fins, the water and the waste gases circulate in the same direction and in the radiator 98, the water and the air circulate in counterflow. This is in order to simplify the positioning of the components concerned. Secondly, these gases are expanded in the expansion chamber 96 and, during this operation, they are cooled again to a temperature significantly lower than that of the ambient air. An appropriate fraction of these greatly cooled waste gases is selected by the by-pass valve 104 which operates under the action of a control signal processed by the calculation circuit 114, from a signal representative of the engine speed. By means of the duct 110, this fraction of cold waste gases returns to the diesel engine 70 in order to be mixed there with the air injected into the cylinders. Under these conditions, the proportion of oxygen which the mixture contains, at low and moderate engine speeds, can be easily taken to a sufficiently low value, which corresponds to stoichiometric proportions of gas oil and oxygen-depleted air. This then prevents any production of nitrogen oxides (NOₓ) which are highly polluting and makes it possible, for the first time, to achieve under good conditions the desire which has long been expressed by numerous engineers who are specialists in diesel engines.

According to FIG. 5, a cooling device 110, with water in a laminar flow, for a microprocessor, comprises a radiator 112, with hollow and thin fins made of a suitable polymer, for example polypropylene, provided with transverse manifolds 113-115, directly connected to the manifolds of an original component 114, formed by a mini-heater 116 and a mini-pump 118.

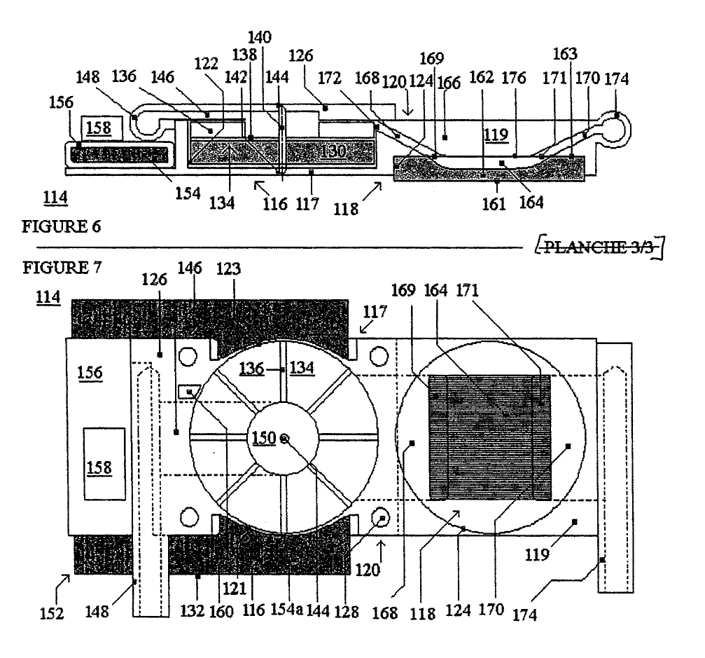

According to FIGS. 6 and 7, the component 114 (represented transparent for the purposes of the description) comprises a block 120 made of rigid moulded polymer, with an approximately rectangular shape of 80×40 mm² and of 10 mm average thickness. This block 120 comprises the hose 119 of the mini-heater 116 and the body 117 of the mini-pump 118, in which two cavities 122 and 124 are provided, allocated to these components 118 and 116 respectively. These cavities 122 and 124 are cylindrical and have respectively as diameters and depths 31 and 8 mm for the first and 30 and 2 mm for the second.

The cavity 122 is provided with a lid 126, which is adapted to be applied in a tight manner onto the block 120 and fixed to it, by means of four screws such as 128 and an O-ring (not shown). In the cavity 122 of the body 117 there is installed, with a slight clearance, a roller 130 with a single diametral magnetization, with a 30 mm diameter and 3 mm thickness, which constitutes the rotor of a brushless electric motor 132. On the upper face of this roller 130 there is attached a centrifugal turbine 134, made of moulded polymer, comprising eight radial vanes 136 of 10 mm in length and 3 mm in height, arranged in a ring on a disk 138, stuck to the roller 130. The roller 130 and the turbine 134 are integral with a shaft 140, mounted to turn between two depressions 142-144, arranged in the bottom of the cavity 122 and in the internal face of the lid 126. In the lid 126, a flat duct 146 is provided which is 10 mm wide and 3 mm thick, connected to the upstream manifold 148 of the composite device 114, which ends in a semi-circle and opens above the freed up center 150 of the centrifugal turbine 134. The electric motor 132 comprises a stator 152, constituted by two flat parts made of soft iron 154 a-b, in an L-shape, engaged in a flattened winding 156. The poles A-B of the magnetic circuit 154 a-b of the stator 152 have the shape of 90° arcs of a circle, which face two diametrically opposite 90° thin parts 121-123, of the cylindrical wall of the cavity 122 containing the rotor 130. These two thin parts 121-123 constitute fractions of the air-gaps in the magnetic circuit of the motor 132. The winding 156 of the electric motor 132 is supplied by an electronic circuit 158, of a known type, associated with a detector 160 for the angular position of the rotor 130.

The heating plate 162 of a mini-heater 116 is forcibly inserted into the cavity 124 of the hose 119, which plate is a copper disk 30 mm in diameter and 2 mm thick. The outer face 161 of this disk is precision-ground and the central part of its internal face 163, hollowed out with micro-grooves 164 of 0.1 mm in width, with a pitch of 0.2 mm, separated by 1 mm high fins. The part 166 of the hose 119 is crossed over by two flat oblique ducts 168-170, 2 mm thick and 20 mm wide, constituting the upstream and downstream manifolds of the mini-heater 116. By means of an extended opening 172, the duct 168 communicates with the cavity 122, at the level of the vanes 136 of the turbine 134, then it opens at 169, above the two last millimetres of the ends upstream of the micro-grooves 164. The duct 170 itself starts at 171, above the two last millimetres of the ends downstream of these micro-grooves 164, and it joins the downstream manifold 174 of the composite device 114. Between the two outlets 169-171 of the ducts 168-170, there is a flat rectangular face 176 which constitutes the lid of the central part of the micro-grooves 164 and thus transforms them into micro-channels forming the internal cavity of the mini-heater 116.

By means of these arrangements, a water cooler for very high-performance microprocessors is produced, the bulk and the efficiency of which allow its use in computers of small dimensions. It will be noted that, if the dimensions of the novel component formed by the combination of an appropriate mini-pump and a mini-heater are small by construction, those of the radiator with hollow and thin fins which must be associated with it can be also. Since the thermal resistance of such a radiator depends on the total surface area, the internal thickness and the thermal conductivity of its fins, it is possible to obtain the desired total surface area by reducing the width (up to 10 mm, for example), and increasing the number thereof.

The disk shape given to the heating plate 162 of the mini-heater 116, represented in FIGS. 6-7, is not of course the only one possible. In fact, any other shape, rectangular or square, of this heating plate, can be suitable, once it can sufficiently project over that of the very hot zone of the heat dissipation surface of the microprocessors concerned and be perfectly inserted in a tight manner into the cavity intended for it, provided in the hose 119.

The combination, in a single component, of the appropriate mini-pump and mini-heater, according to the invention, is not the only way to use these two adjacent components of a laminar flow water cooler. It is possible to associate each of them with a commercially available device having the supplementary function, when this device satisfies the minimum determined specifications. In such a case, for a mini-heater 116, its upstream and downstream manifolds will no longer be the oblique ducts 168-170, but two ducts perpendicular to the grooves in the heating plate which will open directly above the ends of these grooves. These two new manifolds will reduce the space requirement of any mini-heater 116 according to the invention, intended to be associated with a commercially available mini-pump and they will play the same geometrical role as the upstream and downstream manifolds 148 and 174 of the composite device 114. A similar solution will be adopted for a mini-pump 118 used with an appropriate commercially available mini-heater.

It will be noted that the heating plate 162 and the mini-heater 116 both constitute new industrial products which, a priori, can only be manufactured, and if appropriate marketed alone to be part of a laminar flow water cooler, according to the invention. The same applies to the new component 114 comprising a mini-heater 116 and a mini-pump 118. Such a heating plate, such a mini-heater and such a component are an integral part of the present invention. As regards the mini-pump 118, its possible uses can obviously exceed the field of devices for cooling by heat exchange between a hot liquid and a cold fluid for which it was developed.

For internal combustion engines and PEM-type fuel cells, the invention is not limited to the case of motor vehicles equipped with these engines or these cells, since these engines and these cells can obviously be used in a stationary manner for all sorts of applications.

Moreover, in the case of internal combustion engines and PEM-type fuel cells, the invention is not limited to water/air heat exchanges. For the cooling of marine engines, it is common to use an appropriate heat exchanger, in order to keep the primary cooling water of the engine at approximately 80° C. and heat sea water which is pumped cold and then evacuated warm, completely safely and efficiently. The adaptation of a cooler according to the invention to the case of a marine engine therefore involves simply replacing the fan which is adapted for blowing air between the hollow fins of heat exchangers operating in a radiator with a pump which is adapted to circulate sea water in a jacket surrounding these exchangers. In the case of the internal combustion engine of a small power plant or of a stationary PEM-type fuel cell, a similar arrangement can be used in order to achieve a co-generation of electricity and domestic hot water.

A cooling device for a heat engine, according to the invention, is not limited to the use of water the temperature range of which is comprised between 60 and 90° C. For very powerful heat engines (>100 kW), the temperature of this water can be situated between 110 and 180° C. with boost pressures of 3 or 4 bars (the case of Formula 1 engines). The single-piece heat exchangers used are made of metal or glass and suited to the high pressures used. In this same case, an efficient cooler is necessary for the engine oil and the hot liquid is then this oil, the cold fluid still being air.

The improved cooling devices according to the invention can also relate to certain specific high-tech components which, on the one hand, must operate at a determined temperature setting, with a significantly negative value, and which, on the other hand, are subject to the disruptive action of any internal or external heat source. In this case, the <<hot>> liquid is for example alcohol and the cold fluid a gas or a commercially available liquid, the temperature of which at its working pressure is significantly less than the temperature recommended for the components concerned.

1. A cooling device with heat exchange between a hot liquid and a cold fluid, intended to be coupled to a heat dissipation surface of a given component or coupled by construction to this surface, said component being intended to dissipate a given heat flow, situated in determined ranges of powers and temperatures, comprising:
a heater suited to said heat flow, comprising an internal cavity, provided with two manifolds, and a coupling surface corresponding to said heat dissipation surface;
a finned-radiator with hollow and rigid fins, suited to said heat flow, provided with two manifolds;
ducts for connecting together the manifolds of the heater and of the radiator and thus constituting a tight enclosure;
a hot liquid, in particular water, in this enclosure;
means for circulating, in a closed circuit, this hot liquid in said enclosure;
means for circulating the cold fluid, in particular air, between the fins of the radiator; wherein:
said radiator is formed by one or more heat exchangers of a specific type, each constituted by a stack of hollow and thin fins, connected to two transverse manifolds, and each hollow fin is rigid because of the embossing of its walls.

2. A cooling device according to claim 1, wherein said means for circulating the hot liquid are adapted:
to produce a laminar flow of this liquid in the hollow and thin fins of the radiator as well as, if appropriate, in the internal cavity of the heater;
and, preferably, to circulate this liquid in counterflow to the cold fluid which circulates between these fins.

3. A cooling device according to claim 1, wherein said hollow-finned radiator is constituted by one or more single-piece elements, made of polymer or glass, capable of withstanding a maximum temperature and pressure of the hot liquid, an average thickness of the walls of these fins is comprised between about 0.5 and 1 mm, that of their internal channel comprised between about 0.5 and 2.5 mm and the average gap between these fins 3 to 6 mm, when the cold fluid is air.

4. A cooling device, according to claim 1, wherein said hollow-finned radiator is metal and capable of withstanding a maximum temperature and pressure of the hot liquid, an average thickness of the walls of these fins is comprised between about 0.2 and 0.5 mm, that of their internal channel comprised between about 0.5 and 1.5 mm and an average gap between these fins 3 to 6 mm, when the cold fluid is air.

5. A cooling device, according to claim 1, for an internal combustion engine, wherein:
the radiator comprises several heat exchangers with hollow and thin fins, mounted in parallel;
a pump circulates water in a laminar flow in the hollow fins of the radiator;
a fan arranged downstream of an air inlet circulates air between these hollow fins, in counterflow to the water circulating inside.

6. A cooling device according to claim 1, for a PEM-type fuel cell, constituted by a stack of cells equipped with bipolar plates, the central parts of which are passed over by cooling mini-channels, wherein:
the radiator comprises several heat exchangers with hollow and thin fins, mounted in parallel;
a pump circulates water in a laminar flow, in the hollow fins of the radiator and in the mini-channels for cooling of the cells;
a fan arranged downstream of an air inlet circulates air between these hollow fins, in counterflow to the water circulating inside.

7. A cooling device according to claim 6, for a PEM-type fuel cell, installed in a motor vehicle wherein the radiator, the pump, the fan and the air inlet are duplicated in order to form two assemblies respectively installed to the right and to the left of the engine or the cell.

8. A cooling device according to claim 1, for an internal combustion engine or PEM cell, wherein:
the cold fluid is water
the hollow-finned radiator is surrounded by a jacket;
a pump is adapted to circulate this water in said jacket, in counterflow to the hot liquid circulating in said fins;
in the case of a marine engine, the cold fluid is sea water;
in the case of an internal combustion engine of a small power plant or of a PEM cell installed in a stationary manner, the cold fluid is soft water, so as to achieve a co-generation of electricity and domestic hot water.

9. A cooling device according to claim 1, intended to constitute a supplementary cooler for a diesel engine, in order to produce cooled waste gases which can be used to improve the operation of this type of engine, wherein:
the heater is constituted by one or more heat exchangers with hollow and thin metal fins, installed in an appropriate chamber, arranged upstream of the usual expansion chamber of the exhaust pipe for the waste gases;
the radiator is formed by several heat exchangers with hollow and thin fins, mounted in parallel;
a pump is adapted to circulate water in a closed circuit and in a laminar flow in the tight enclosure formed by the heater and the radiator;
a fan is adapted to circulate air between the hollow fins of the radiator, in counterflow to water which circulates in said fins.

10. A cooling device according to claim 1, for components with a precision-ground flat heat dissipation surface, wherein:
where the means for circulating the hot liquid must be constituted simply by natural convection, the heater and the radiator are installed in such a way that the currents of hot liquid which pass over them are substantially vertical;
upstream orifices of the heater and of the radiator are separated by a minimal gap, which is capable of producing a nominal flow rate of hot liquid, corresponding both to the heat flow to be dissipated in the radiator ventilated by the current of available air and to maintaining a maximum temperature of this liquid below a determined upper limit, specific to the component concerned;
ducts comprising the internal cavity of the heater, its upstream and downstream manifolds as well as the connections connecting the latter to the orifices of the radiator exhibit pressure drops which are as small as possible, compatible with a sufficient minimum thermal conductance of the heater;
hot liquid can circulate either by simple expansion or mainly by production of a mixture of liquid and bubbles of vapor.

11. A cooling device according to claim 10, wherein with a minimum gap between the upstream orifices of the mini-heater and of the radiator of the order of a decimetre, a hot liquid circulating by natural convection is water at atmospheric pressure.

12. A cooling device according to claim 10, wherein with a minimum gap between the upstream orifices of the heater and of the radiator of the order of a centimetre, a hot liquid, in particular water at low pressure, can undergo a change of state liquid/vapor, at a temperature at least a few degrees below an upper limit imposed on the component to be cooled, so that a two-phase mixture of liquid and bubbles of vapor trapped in the liquid can be constituted and circulate in a closed circuit simply by natural convection, in the enclosure formed by the heater and the radiator.

13. A cooling device according to claim 3, for components with a flat and precision-ground heat dissipation surface wherein:
the heater is a mini-heater suited to its function, which comprises a heating plate, made of metal with high thermal conductivity, and a rigid hose made of moulded polymer;
the heating plate is provided with a precision-ground outer coupling face, corresponding to said heat dissipation surface, and an initially flat internal face, the central part of which is hollowed out with parallel grooves with dimensions, pitch and number, determined by the density and the intensity of the heat flow to be dissipated;
the hose incorporates two upstream and downstream manifolds opening on either side of a flat rectangular central zone of its internal face;
the heating plate is fixed in a tight manner to the internal face of the hose;
said flat rectangular central zone of the internal face of the hose is applied to the grooved part of the internal face of the heating plate, so as to serve as a partial lid for it and thus constitute the internal cavity of the mini-heater and free up the upstream and downstream orifices of this internal cavity.

14. A cooling device, according to claim 13, for a microprocessor with high or moderate performance, the precision-ground heat dissipation plate comprises a small central zone which is slightly hotter, wherein:
the width of the grooves of the heating plate is comprised between about 0.5 and 1.5 mm, their depth is, as a decreasing function, about five to eight times their width and twice their pitch;
the grooved central part of the internal face of the heating plate projects well over said hotter central zone of the microprocessor;
the thickness of the heating plate is substantially half the depth of the grooves;
the manifolds of the mini-heater are in alignment with the grooves of the heating plate.
thermosiphon means can be used in order to circulate the hot liquid.

15. (canceled)

16. A cooling device according to claim 13, for a very high-performance microprocessor, the precision-ground heat dissipation plate of which comprises a small very hot central zone, wherein:
width of the grooves of the heating plate is as small as possible, i.e. less than about 0.2 mm, their depth is, as a decreasing function, substantially ten to fifteen times this width and substantially twice their pitch;
a grooved central part of the internal face of the heating plate projects well over said small very hot central zone of the microprocessor;
a heating plate of the appropriate mini-heater is inserted and fixed in a tight manner in a cavity, made in the hose;
a thickness of the heating plate is about twice the depth of the grooves;
a pump is used to circulate the hot liquid.

17. A cooling device according to claim 3, for a high or very high-performance microprocessor, comprising a mini-heater and a mini-pump, suited to its function, wherein:
this mini-pump comprises a brushless electric motor, provided with a rotor, in the form of a roller with a single diametral magnetization and a centrifugal turbine, integral with this rotor;
the body of this mini-pump is made of rigid moulded polymer and it comprises a cylindrical cavity, provided with a tight lid;
the rotor-turbine assembly is enclosed with a slight clearance in this cavity;
the rotor-turbine assembly is rotatably mounted on a shaft turning in two small depressions arranged in the bottom of this cavity and in the internal face of this lid;
the turbine is constituted by vanes, arranged in a ring on a disk;
a water inlet duct, arranged in the lid, is connected to the upstream manifold of the mini-pump and opens at the center of this ring;
a water outlet opening is arranged in a wall of the cavity, at the level of the vanes of the turbine;
two parts, diametrically opposite the wall of the cavity, are cylinder portions with a thin wall and the poles of the stator of the electric motor fits against these wall parts;
the stator of the electric motor comprises a winding, supplied by an electronic circuit, which is adapted to start the motor then making it turn up to an appropriate speed.

18. A cooling device for microprocessors, according to claim 16, wherein the hose of the mini-heater and the body of the mini-pump constitute the two juxtaposed parts of the same block, made of rigid moulded polymer, in which the inlet to the upstream manifold of the mini-heater and a water outlet of the mini-pump are merged, the upstream manifold of the mini-pump and the downstream manifold of the mini-heater being respectively the upstream and downstream manifolds of an original component, which manifolds are perpendicular to the grooves of the heating plate of the mini-heater.

19-21. (canceled)

22. A mini-pump, in particular for a cooling device, according to claim 16, wherein:
it comprises a brushless electric motor, provided with a rotor in the form of a roller with a single diametral magnetization and a centrifugal turbine, integral with this rotor;
a body of this mini-pump is made of rigid moulded polymer and it comprises a cylindrical cavity, provided with a tight lid;
a rotor-turbine assembly is enclosed with a slight clearance in this cavity;
the rotor-turbine assembly is rotatably mounted on a shaft, turning in two small depressions, arranged in the bottom of this cavity and in an internal face of this lid;
the turbine is constituted by vanes, arranged in a ring on a disk;
a water inlet duct, arranged in the lid, is connected to the upstream manifold of the mini-pump and opens at the center of this ring;
a water outlet opening is arranged in the wall of the cavity, at the level of the vanes of the turbine;
two parts, diametrically opposite the wall of the cavity, are cylinder portions with a thin wall and the poles of the stator of the electric motor fit against these wall parts;
the stator of the electric motor comprises a winding, supplied by an electronic circuit which is adapted to start the motor then making it turn up to an appropriate speed.

23. A component formed by the combination of a mini-heater and a mini-pump, intended to be incorporated in a cooling device according to claim 16, for high and very high-performance microprocessors, the flat precision-ground heat dissipation surface of which comprises a small very hot central zone, wherein:
the mini-heater comprises a heating plate, made of metal with high thermal conductivity, and a rigid hose made of moulded polymer;
the heating plate is provided with a precision-ground outer coupling face, corresponding to said heat dissipation surface, and an initially flat internal face, the central part of which is sunk with parallel grooves;
a width of the grooves of the heating plate is as small as possible, i.e. less than about 0.2 mm, their depth is, as a decreasing function, substantially ten to fifteen times this width and substantially twice their pitch;
a central grooved part of the internal face of the heating plate projects well over said small very hot central zone of the microprocessors;
a thickness of the heating plate is about twice the depth of the grooves;
a hose incorporates two upstream and downstream manifolds, opening on either side of a flat rectangular central zone of its internal face;
the heating plates is fixed in a tight manner to the internal face of the hose;
said flat rectangular central zone of the internal face of the hose is applied to the grooved part of an internal face of the heating plate, so as to serve as a partial lid for it and thus constitute the internal cavity of the mini-heater and free up the upstream and downstream orifices of this internal cavity;
the mini-pump comprises a brushless electric motor, provided with a rotor, in the form of a roller with a single diametral magnetization and a centrifugal turbine, integral with this rotor;
the body of this mini-pump is made of rigid moulded polymer and it comprises a cylindrical cavity, provided with a tight lid;
the rotor-turbine assembly is enclosed with a slight clearance in this cavity;
the rotor-turbine assembly is rotatably mounted on a shaft turning in two small depressions, arranged in the bottom of this cavity and in the internal face of this lid;
the turbine is constituted by vanes arranged in a ring on a disk;
a water inlet duct, arranged in the lid, is connected to an upstream manifold of the mini-pump and opens at the center of this ring;
a water outlet opening is arranged in the wall of the cavity, at the level of the vanes of the turbine;
two parts, diametrically opposite a wall of the cavity, are cylinder portions with a thin wall and the poles of the stator of the electric motor fit against these wall parts;
the stator of the electric motor comprises a winding, supplied by an electronic circuit, which is adapted to start the motor then making it turn up to an appropriate speed;
the hose of the mini-heater and a body of the mini-pump constitute the two juxtaposed parts of the same block, made of rigid moulded polymer, in which the inlet to the upstream manifold of the mini-heater and the water outlet from the mini-pump are merged an upstream manifold of the mini-pump and a downstream manifold of the mini-heater, being respectively the upstream and downstream manifolds of the component, which manifolds are perpendicular to the grooves of the heating plate of the mini-heater.
